(19) United States
(12) Patent Application Publication
(10) Pub. No.: US 2020/0071895 A1
(43) Pub. Date: Mar. 5, 2020

(54) Snow Shovel Blower Apparatus and Methods of Using the Same

(71) Applicant: Daniel C. Bolon, Strongsville, OH (US)

(72) Inventor: Daniel C. Bolon, Strongsville, OH (US)

(21) Appl. No.: 16/114,936

(22) Filed: Aug. 28, 2018

(51) Int. Cl. E01H 5/07; E01H 5/02

(52) U.S. Cl. CPC E01H 5/07; A01G 20/47; E01H 5/02

(57) ABSTRACT

A snow shovel blower apparatus comprises a tubular attachment for a leaf blower or other like motor for blowing forced air through a tube. The snow shovel blower apparatus comprises an attachment end and a snow shovel end, wherein the attachment end attaches to a tube extending from a leaf blower or other like motor, and the snow shovel end comprises a snow shovel scoop extending from the tube, having an air directing element for directing forced air across the face of the scoop and towards an edge of the snow shovel scoop. The forced air aids in moving snow from a surface, such as a walkway, driveway, sidewalk, porch, deck or other like surface.

### TECHNICAL FIELD

The present invention relates to a snow shovel blower apparatus. Specifically, the snow shovel blower apparatus comprises a tubular attachment for a leaf blower or other like motor for blowing forced air through a tube. The snow shovel blower apparatus comprises an attachment end and a snow shovel end, wherein the attachment end attaches to a tube extending from a leaf blower or other like motor, and the snow shovel end comprises a snow shovel scoop extending from the tube, having an air directing element for directing air across the face of the scoop and towards an edge of the snow shovel scoop. The forced air aids in moving snow from a surface, such as a walkway, driveway, sidewalk, porch, deck or other like surface.

### BACKGROUND

Snow shovels, of course, have been around for centuries, if not millennia. Indeed, the earliest evidence of a snow shovel was found in a bog in Russia and is estimated to be roughly 6,000 years old. It was made from a sharpened Elk antler that was tied to a handle and was utilized to clear snow from surfaces. Many different kinds of snow shovels have been created over the years, but they all share the obvious property of moving or removing snow from a surface, such as a walkway, driveway, sidewalk, porch, deck or other like surface.

Most snow shovels are designed for either pushing snow across a surface or lifting snow for tossing, although some are crossovers which can do either job. Some snow shovel scoops have sharpened blades on an edge of the scoops which can chip away and lever up slabs of ice.

Handles may be straight or bent, long or short, and may be made from many different materials, such as metal, plastic or wood. Scoops can be shallow (for pushing snow) or deep (for lifting and/or tossing snow), and also may be made from various materials, typically plastic or metal.

Shoveling snow can be tedious, hard work that may pose risks, especially to the elderly and infirm. Health risks associated with snow shoveling include heart attacks, breathing issues, muscles strain, falls, back injuries, frostbite, hypothermia, and accidents involving road traffic. The amount of snow that typically must be moved during a winter season from, for example, a driveway or walkways, can easily measure in the tons of snow. A need, therefore, exists for an apparatus that makes it easier to move or remove snow from a surface. More specifically, a need exists for an apparatus that is safer to use than a traditional snow shovel.

Many have attempted to solve some of these issues by changing the shape and size of handles and/or scoops, some of which are mentioned above. However, none of these changes significantly reduce the effort that a user may need to expend to clear snow from a surface.

Mechanical snow throwers, also known as snow blowers, use electricity or fuel to spin one or more blades for chopping and/or throwing snow away from a surface. Specifically, a typical snow thrower includes a rotating axle having a plurality of blades that chop and direct snow into a chute, wherein the chute may be adjusted to direct the snow to a particular direction. Other snow throwers utilize rotating bristles to clear snow from a surface. While snow throwers may do an effective job moving a large amount of snow, they are often large, heavy, cumbersome machines that typically require significant electricity or fuel consumption. Many people have difficulty using snow throwers due to their unwieldiness and their cost. A need, therefore, exists for a snow moving apparatus that is easy to use and relatively small and lightweight so as to be useful to individuals, especially those that cannot effectively use larger, heavier machines. Moreover, a need exists for a snow moving apparatus that consumes less electricity or fuel compared to existing snow throwers, and is therefore less expensive to operate.

In addition, typical mechanical snow throwers require a user to purchase a full machine, including a motor, to utilize. The motors are typically built into the machine, and typically cannot be separated therefrom and used for a different purpose. Therefore, once the winter season is over, the mechanical snow throwers are often stored away until the next season without further use. When restarting a snow thrower, significant work and maintenance may be required due to the length of time the snow thrower was in storage. A need, therefore, exists for a snow moving apparatus that may be modular and removed from a motor so that the motor may be utilized for a different purpose. More specifically, a need exists for a snow moving apparatus that may attached to a traditional leaf blower so that the leaf blower motor may be utilized all year long, either to move leaves or grass, for example, or to move snow in the winter time.

### SUMMARY OF THE INVENTION

The present invention relates to a snow shovel blower apparatus. Specifically, the snow shovel blower apparatus comprises a tubular attachment for a leaf blower or other like motor for blowing forced air through a tube. The snow shovel blower apparatus comprises an attachment end and a snow shovel end, wherein the attachment end attaches to a tube extending from a leaf blower or other like motor, and the snow shovel end comprises a snow shovel scoop extending from the tube, having an air directing element for directing air across the face of the scoop and towards an edge of the snow shovel scoop. The forced air aids in moving snow from a surface, such as a walkway, driveway, sidewalk, porch, deck or other like surface.

To this end, in an embodiment of the present invention, a snow shovel blower apparatus is provided. The snow shovel blower apparatus comprises: a tube comprising a first end and a second end, wherein the first end comprises an attachment element configured to attach the first end of the tube to a motorized apparatus that pushes forced air therefrom; a shovel scoop comprising a top surface, a bottom surface, a first end, a second end, a first side and a second side, wherein the first end of the shovel scoop is connected to the second end of the tube and the second end comprises and edge configured to contact snow for moving the snow; and a deflection element at the first end of the shovel, wherein the deflection element is configured to fan forced air through the tube over the top surface between the first side and the second side.

In an embodiment, the deflection element comprises an opening between the tube and the shovel scoop that is smaller in size than the diameter of the tube for accelerating air forced through the tube over the top surface of the shovel.

In an embodiment, the deflection element comprises a panel extending from the first side to the second side of the shovel scoop on the first end of the shovel scoop, wherein the panel is disposed a distance above the top surface of the shovel scoop.

In an embodiment, the deflection element comprises a downwardly angled plate extending from the top of the second end of the tube toward the first end of the shovel scoop, forming an opening smaller than the size of the tube for accelerating forced air therethrough.

In an embodiment, the deflection element comprises a panel extending from the first side to the second side of the shovel scoop on the first end of the shovel scoop, wherein the panel is disposed a distance above the top surface of the shovel scoop and forms a chamber, and a downwardly angled plate extending from the top of the second end of the tube to the panel, forming an opening smaller than the size of the tube for accelerating forced air therethrough into the chamber beneath the panel.

In an embodiment, the tube is a first tube and the attachment element is configured to attach the first end of the first tube to a second tube that extends from the motorized apparatus that pushes forced air therefrom.

In an embodiment, the motorized apparatus that pushes forced air therefrom is a leaf blower.

In an embodiment, the shovel scoop comprises a plurality of parallel ridges within the top surface thereof and configured to direct forced air between the parallel ridges toward the second end of the shovel scoop.

In an embodiment, the snow shovel blower apparatus further comprises: a motorized apparatus that pushes forced air therefrom connected to the first end of the tube.

In an embodiment, the tube is a first tube, and further comprises: a second tube connected to the first end of the first tube; and a motorized apparatus that pushes forced air therefrom connected to the second tube.

In an alternate embodiment of the present invention, a method of using a snow shovel blower apparatus is provided. The method comprises the steps of: providing a snow shovel blower apparatus comprising: a tube comprising a first end and a second end, wherein the first end comprises an attachment element configured to attach the first end of the tube to a motorized apparatus that pushes forced air therefrom; a shovel scoop comprising a top surface, a bottom surface, a first end, a second end, a first side and a second side, wherein the first end of the shovel scoop is connected to the second end of the tube and the second end comprises and edge configured to contact snow for moving the snow; and a deflection element at the first end of the shovel, wherein the deflection element is configured to fan forced air through the tube over the top surface between the first side and the second side; attaching the snow shovel blower apparatus to the motorized apparatus that pushes forced air therefrom; pushing forced air from the motorized apparatus through the tube over the top surface of the shovel scoop toward the second end of the shovel scoop; aligning the second end of the shovel scoop with a surface having an amount of snow thereon; pushing the second end of the shovel scoop along the surface; and moving the amount of snow from the surface via the forced air pushed over the top surface of the shovel scoop.

In an embodiment, the deflection element comprises an opening between the tube and the shovel scoop that is smaller in size than the diameter of the tube for accelerating air forced through the tube over the top surface of the shovel, and comprises the step of: accelerating the forced air pushed through the tube from the motorized apparatus through the opening.

In an embodiment, the deflection element comprises a panel extending from the first side to the second side of the shovel scoop on the first end of the shovel scoop, wherein the panel is disposed a distance above the top surface of the shovel scoop.

In an embodiment, the deflection element comprises a downwardly angled plate extending from the top of the second end of the tube toward the first end of the shovel scoop, forming an opening smaller than the size of the tube for accelerating forced air therethrough, and comprises the step of: accelerating the forced air pushed through the tube from the motorized apparatus through the opening.

In an embodiment, the deflection element comprises a panel extending from the first side to the second side of the shovel scoop on the first end of the shovel scoop, wherein the panel is disposed a distance above the top surface of the shovel scoop and forms a chamber, and a downwardly angled plate extending from the top of the second end of the tube to the panel, forming an opening smaller than the size of the tube for accelerating forced air therethrough into the chamber beneath the panel, and further comprises the step of: accelerating the forced air pushed through the tube from the motorized apparatus through the opening.

In an embodiment, the tube is a first tube and the attachment element is configured to attach the first end of the first tube to a second tube that extends from the motorized apparatus that pushes forced air therefrom, and comprises the step of: attaching the first end of the first tube to the second tube.

In an embodiment, the motorized apparatus that pushes forced air therefrom is a leaf blower.

In an embodiment, the shovel scoop comprises a plurality of parallel ridges within the top surface thereof and configured to direct forced air between the parallel ridges toward the second end of the shovel scoop.

In an embodiment, the method further comprises the step of: pushing the forced air from the tube via the motorized apparatus onto the top surface of the shovel scoop between the parallel ridges.

In an embodiment, the method further comprises the step of: moving the amount of snow from the surface via a combination of pushing the snow with the second end of the shovel scoop and pushing the snow with the forced air pushed over the top surface of the shovel scoop.

It is, therefore, an advantage and objective of the present invention to provide an apparatus that makes it easier to move or remove snow from a surface.

More specifically, it is an advantage and objective of the present invention to provide an apparatus that is safer to use than a traditional snow shovel.

In addition, it is an advantage and objective of the present invention to provide a snow moving apparatus that is easy to use and relatively small and lightweight so as to be useful to individuals, especially those that cannot effectively use larger, heavier machines.

Moreover, it is an advantage and objective of the present invention to provide a snow moving apparatus that consumes less electricity or fuel compared to existing snow throwers, and is therefore less expensive to operate.

Further, it is an advantage and objective of the present invention to provide a snow moving apparatus that may be modular and removed from a motor so that the motor may be utilized for a different purpose.

Still further, it is an advantage and objective of the present invention to provide a snow moving apparatus that may attached to a traditional leaf blower so that the leaf blower motor may be utilized all year long, either to move leaves or grass, for example, or to move snow in the winter time.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a snow shovel blower apparatus in an embodiment of the present invention.

FIG. 2 illustrates a perspective view of a snow shovel blower apparatus connected to a leaf blower in an embodiment of the present invention.

FIG. 3 illustrates a close-up overhead view of a snow shovel scoop in an embodiment of the present invention.

FIG. 4 illustrates a cross-sectional view along line IV-IV of a snow shovel blower apparatus in an embodiment of the present invention.

FIG. 5 illustrates a perspective view of a user using a snow shovel blower apparatus to move snow therewith from a surface in an embodiment of the present invention.

### DETAILED DESCRIPTION OF THE PRESENTLY PREFERRED EMBODIMENTS

The present invention relates to a snow shovel blower apparatus. Specifically, the snow shovel blower apparatus comprises a tubular attachment for a leaf blower or other like motor for blowing forced air through a tube. The snow shovel blower apparatus comprises an attachment end and a snow shovel end, wherein the attachment end attaches to a tube extending from a leaf blower or other like motor, and the snow shovel end comprises a snow shovel scoop extending from the tube, having an air directing element for directing air across the face of the scoop and towards an edge of the snow shovel scoop. The forced air aids in moving snow from a surface, such as a walkway, driveway, sidewalk, porch, deck or other like surface.

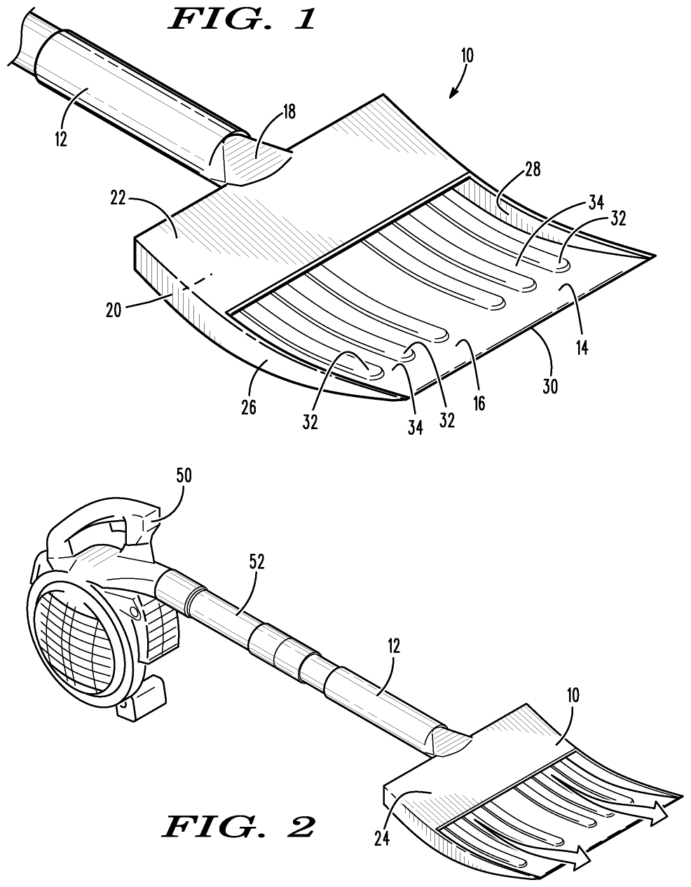

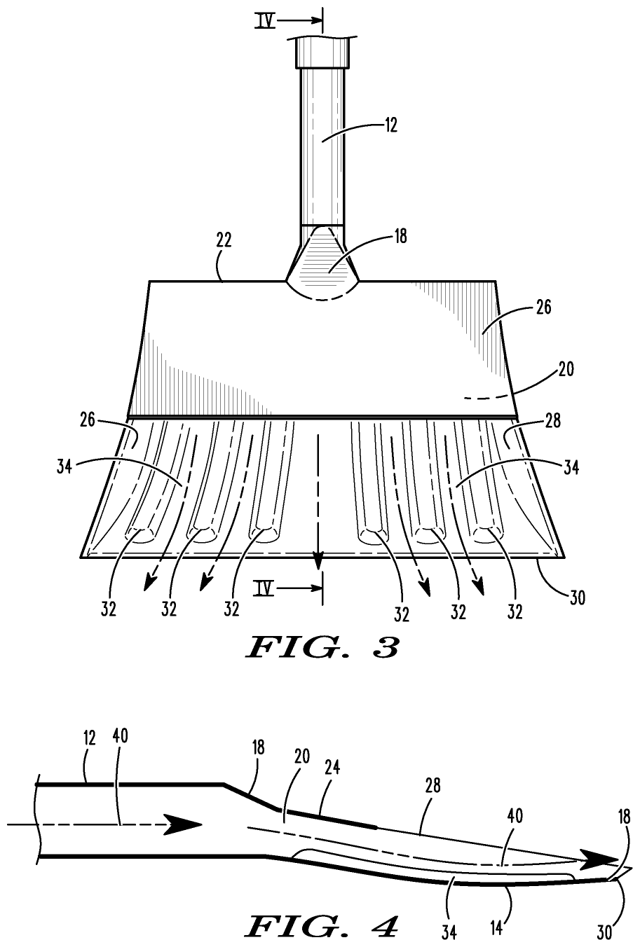

Now referring to the figures, wherein like numerals refer to like parts, FIG. 1 illustrates a snow shovel blower apparatus 10 in an embodiment of the present invention. The snow shovel blower apparatus 10 comprises an air tube 12 attached to a snow shovel scoop 14, wherein pumped air from a blower 50, such as a leaf blower, as illustrated in FIG. 2, may blow air therethrough at relatively high velocity and over a top surface 16 of the snow shovel scoop 14. The air tube 12 may preferably be attachable to and detachable from a blower tube 52 so as to separate therefrom so that the snow shovel blower apparatus 10 is used when needed with the blower. For example, if the blower 50 is a leaf blower, as illustrated in FIG. 2, then the snow shovel blower apparatus 10 may be utilized by attaching the same to the blower tube 52 of the leaf blower 50 and used when needed.

The air tube 12 may have connector elements (now shown) that allow the same to be rigidly connected to the blower tube 52 or otherwise to the blower 50, as needed. For example, a terminal end of the air tube 12 may include connector pins, nubs, raised portions, slots, buttons, pegs, bolts, or other like connector elements that allow the air tube 12 so as to be rigidly held to the blower tube 52 or directly to the blower 50.

Alternatively, the snow shovel blower apparatus 10 may be integrally and permanently connected to a blower for use when needed for blowing and shoveling snow, as described in more detail below.

At the connection point between the air tube 12 and the snow shovel scoop 14 may have an air deflector 18, which may deflect the high velocity air blowing therethrough and into a chamber 20 on a back end 22 of the snow shovel scoop 14 that is formed from a panel 24 extending from a first side wall 26 to a second side wall 28 of the snow shovel scoop 14. As air flows through air tube 12 and into chamber 20, it is deflected by deflector 18 toward the top surface 16 of the snow shovel scoop 14. Therefore, high velocity air may be pushed down the top surface 16 of the snow shovel scoop 14 toward and over edge 30 of the snow shovel scoop 14. Edge 30 may be bladed as is typical of snow shovel scoops to aid in cutting and moving snow.

FIG. 4 illustrates a cross-sectional view of the snow shovel blower apparatus 10 along line IV-IV, illustrates air flow 40 through the air tube 12, past deflector 18, into chamber 20, along top surface 18 of snow shovel scoop 14, and over and past edge 30.

The top surface 16 of the snow shovel scoop 14 may contain ridges 32 that may form a plurality of parallel channels 34 that may aid in directing high speed airflow from the chamber 20 down across the top surface 16 of the snow shovel scoop 14 and over the edge 30 thereof. Thus, the high velocity air flow may be contained and directed through the parallel channels 34 to aid in blowing snow when the edge 30 is directed at snow on a surface.

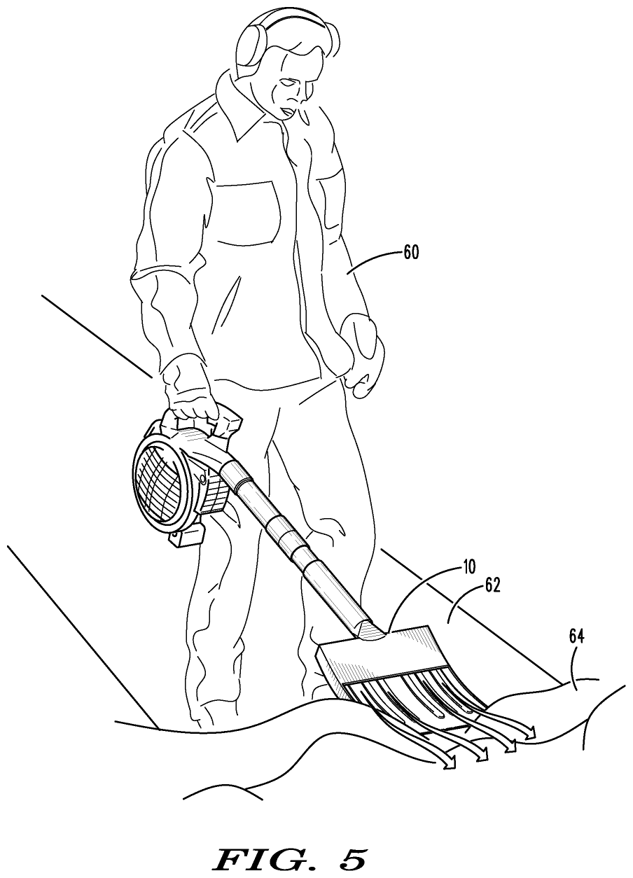

Specifically, as used herein, the edge 30 of the snow shovel scoop 14 may be placed on a surface having an amount of snow thereon and may be utilized as a traditional snow shovel may be utilized. As the high velocity air flows from blower 50 through blower tube 52, through air tube 12, into chamber 20, down top surface 16 and over and past edge 30 of the snow shovel scoop 14, it aids in moving the snow by blowing the same when the edge 30 is moved along the surface. Therefore, less exertion is required to move the snow, and the snow may be easily cleared from the surface using the snow shovel blower apparatus 10, as described herein. FIG. 5 illustrates a user 60 pushing a snow shovel blower apparatus 10, as described herein, along a surface 62 and moving an amount of snow 64 thereby.

The present invention may include certain elements to aid in blowing and otherwise moving snow that are not shown by the drawings, including individual air passages within the chamber 20 that may effectively direct airflow through the chamber 20 to the channels 34 formed by the ridges 32 so that high velocity air may be better spread out along the entirety of the top surface 16 of the snow shovel scoop 14, particularly from sidewall 26 to sidewall 28. Moreover, as noted above, the edge 30 may contain a blade made from a harder material than the snow shovel scoop 14. For example, the snow shovel scoop 14 may be made of relatively lightweight plastic, whereas a blade disposed on edge 30 may be made from a harder, denser plastic or metal.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A snow shovel blower apparatus comprising
a tube comprising a first end and a second end, wherein the first end comprises an attachment element configured to attach the first end of the tube to a motorized apparatus that pushes forced air therefrom;
a shovel scoop comprising a top surface, a bottom surface, a first end, a second end, a first side and a second side, wherein the first end of the shovel scoop is connected to the second end of the tube and the second end comprises and edge configured to contact snow for moving the snow; and
a deflection element at the first end of the shovel, wherein the deflection element is configured to fan forced air through the tube over the top surface between the first side and the second side.

2. The snow shovel blower apparatus of claim 1 wherein the deflection element comprises an opening between the tube and the shovel scoop that is smaller in size than the diameter of the tube for accelerating air forced through the tube over the top surface of the shovel.

3. The snow shovel blower apparatus of claim 1 wherein the deflection element comprises a panel extending from the first side to the second side of the shovel scoop on the first end of the shovel scoop, wherein the panel is disposed a distance above the top surface of the shovel scoop.

4. The snow shovel blower apparatus of claim 1 wherein the deflection element comprises a downwardly angled plate extending from the top of the second end of the tube toward the first end of the shovel scoop, forming an opening smaller than the size of the tube for accelerating forced air therethrough.

5. The snow shovel blower apparatus of claim 1 wherein the deflection element comprises a panel extending from the first side to the second side of the shovel scoop on the first end of the shovel scoop, wherein the panel is disposed a distance above the top surface of the shovel scoop and forms a chamber, and a downwardly angled plate extending from the top of the second end of the tube to the panel, forming an opening smaller than the size of the tube for accelerating forced air therethrough into the chamber beneath the panel.

6. The snow shovel blower apparatus of claim 1 wherein the tube is a first tube and the attachment element is configured to attach the first end of first the tube to a second tube that extends from the motorized apparatus that pushes forced air therefrom.

7. The snow shovel blower apparatus of claim 1 wherein the motorized apparatus that pushes forced air therefrom is a leaf blower.

8. The snow shovel blower apparatus of claim 1 wherein the shovel scoop comprises a plurality of parallel ridges within the top surface thereof and configured to direct forced air between the parallel ridges toward the second end of the shovel scoop.

9. The snow shovel blower apparatus of claim 1 further comprising:
a motorized apparatus that pushes forced air therefrom connected to the first end of the tube.

10. The snow shovel blower apparatus of claim 1 wherein the tube is a first tube, and further comprising:
a second tube connected to the first end of the first tube; and
a motorized apparatus that pushes forced air therefrom connected to the second tube.

11. A method of using a snow shovel blower apparatus comprising the steps of:
providing a snow shovel blower apparatus comprising: a tube comprising a first end and a second end, wherein the first end comprises an attachment element configured to attach the first end of the tube to a motorized apparatus that pushes forced air therefrom; a shovel scoop comprising a top surface, a bottom surface, a first end, a second end, a first side and a second side, wherein the first end of the shovel scoop is connected to the second end of the tube and the second end comprises and edge configured to contact snow for moving the snow; and a deflection element at the first end of the shovel, wherein the deflection element is configured to fan forced air through the tube over the top surface between the first side and the second side;
attaching the snow shovel blower apparatus to the motorized apparatus that pushes forced air therefrom;
pushing forced air from the motorized apparatus through the tube over the top surface of the shovel scoop toward the second end of the shovel scoop;
aligning the second end of the shovel scoop with a surface having an amount of snow thereon;
pushing the second end of the shovel scoop along the surface; and
moving the amount of snow from the surface via the forced air pushed over the top surface of the shovel scoop.

12. The method of claim 11 wherein the deflection element comprises an opening between the tube and the shovel scoop that is smaller in size than the diameter of the tube for accelerating air forced through the tube over the top surface of the shovel, and comprising the step of:
accelerating the forced air pushed through the tube from the motorized apparatus through the opening.

13. The method of claim 11 wherein the deflection element comprises a panel extending from the first side to the second side of the shovel scoop on the first end of the shovel scoop, wherein the panel is disposed a distance above the top surface of the shovel scoop.

14. The method of claim 11 wherein the deflection element comprises a downwardly angled plate extending from the top of the second end of the tube toward the first end of the shovel scoop, forming an opening smaller than the size of the tube for accelerating forced air therethrough, and comprising the step of:
accelerating the forced air pushed through the tube from the motorized apparatus through the opening.

15. The method of claim 11 wherein the deflection element comprises a panel extending from the first side to the second side of the shovel scoop on the first end of the shovel scoop, wherein the panel is disposed a distance above the top surface of the shovel scoop and forms a chamber, and a downwardly angled plate extending from the top of the second end of the tube to the panel, forming an opening smaller than the size of the tube for accelerating forced air therethrough into the chamber beneath the panel, and comprising the step of:
accelerating the forced air pushed through the tube from the motorized apparatus through the opening.

16. The method of claim 11 wherein the tube is a first tube and the attachment element is configured to attach the first end of the first tube to a second tube that extends from the motorized apparatus that pushes forced air therefrom, and comprising the step of:
attaching the first end of the first tube to the second tube.

17. The method of claim 11 wherein the motorized apparatus that pushes forced air therefrom is a leaf blower.

18. The method of claim 11 wherein the shovel scoop comprises a plurality of parallel ridges within the top surface thereof and configured to direct forced air between the parallel ridges toward the second end of the shovel scoop.

19. The method of claim 18 further comprising the step of:
pushing the forced air from the tube via the motorized apparatus onto the top surface of the shovel scoop between the parallel ridges.

20. The method of claim 11 further comprising the step of:
moving the amount of snow from the surface via a combination of pushing the snow with the second end of the shovel scoop and pushing the snow with the forced air pushed over the top surface of the shovel scoop.
